(19) United States
(12) Patent Application Publication
(10) Pub. No.: US 2022/0003033 A1
(43) Pub. Date: Jan. 6, 2022

(54) SUPPORT ELEMENT FOR A MOTOR VEHICLE

(71) Applicant: U-SHIN DEUTSCHLAND ZUGANGSSYSTEME GMBH, Erdweg (DE)

(72) Inventors: Eric BITTNER, Erdweg (DE); Frank KUMMER, Erdweg (DE)

(21) Appl. No.: 17/277,165

(22) PCT Filed: Sep. 13, 2019
(86) PCT No.: PCT/EP2019/074535

§ 371 Date: Mar. 17, 2021

(30) Foreign Application Priority Data
Sep. 20, 2018 (DE) 10 2018 123 186.5

(51) Int. Cl. E05F 1/10; F16F 9/32

(52) U.S. Cl. CPC E05F 1/1058; F16F 9/3242; E05F 1/1091; F16F 9/0218; E05Y 2800/422; E05Y 2201/602; E05Y 2900/531

(57) ABSTRACT

A supporting element, in particular a spring strut, for adjusting a flap or door of a motor vehicle, including a base part, an extendable part that is adjustable relative to the base part, and a spring that is arranged between the two parts, is provided with a noise-reducing coating on the base part and/or extendable part on a surface facing the spring.

### FIELD OF THE INVENTION

This invention relates to a supporting element, in particular a spring strut or a compact spindle, for adjusting a flap or door of a motor vehicle, comprising a base part, an extendable part that is adjustable relative to the base part, and a spring that is arranged between the two parts, wherein a noise-reducing coating is provided.

The term “spring strut” here refers to a gas pressure damper combined with a mechanical spring.

### BACKGROUND OF THE INVENTION

Supporting elements such as spring struts are widely used to support and/or dampen an opening or closing movement of a flap or a door, for example of the liftgate, in a controlled way. The movement of a piston can be supported for example by a coil spring. As the spring usually is supported only at its end, it is able to oscillate in a radial direction, in particular under tension. This leads to the fact that the spring abuts against surrounding components, for example a guide tube, which results in an unwanted generation of noise. An abutment can be caused in particular by the formation of an S-twist of the spring during the opening or closing process or also by vibrations or jolts, for example on uneven roads.

From DE 10 2005 007 741 B4 there is known a piston-cylinder unit comprising a helical compression spring surrounding a cylinder, wherein the spring has an elastic coating designed as a flock coating to reduce the generation of noise. The flock coating is applied over the entire length of the spring at least on the surface directed radially with respect to the cylinder wall.

### SUMMARY OF THE INVENTION

It is the object of the invention to provide a supporting element at low cost, which causes the lowest possible generation of noise.

According to the invention, this object is achieved by a supporting element for adjusting a flap or door of a motor vehicle, comprising a base part, an extendable part that is adjustable relative to the base part, and a spring that is arranged between the two parts, wherein a noise-reducing coating is provided, characterized in that the noise-reducing coating is arranged on the base part and/or extendable part on a surface facing the spring. As compared to the prior art, the coil spring itself need therefore not be provided with a coating, but merely a component facing the spring on its surface. As a result, the noise-reducing coating can be applied with less expenditure, as the corresponding components have a surface with very much less curvature than a spring. Moreover, for example in the case of a plastic tube surrounding the spring, preparatory method steps, for example a surface treatment, can be carried out with less expenditure before applying the noise-reducing coating.

The coating can also be utilized to increase the friction between the components and thereby ensure a secure hold also in intermediate positions. In addition, noise can be dampened effectively during changes in the load condition, for example when stopping in intermediate positions.

According to a preferred embodiment, the noise-reducing coating extends at least over a part of the length of the coated component, in particular at least over a length at which the spring can be in contact with the coating at at least two points in every position of the supporting element. On the one hand, this provides for an inexpensive manufacture, as it is not necessary to provide the entire component with a coating. On the other hand, it is possible to also selectively coat only those points at which the spring abuts to an increased extent.

Alternatively, it is possible that the noise-reducing coating extends over the entire length of the coated component. This allows to simplify the method for applying the coating. Moreover, it can thus be ensured in a simple way that independent of the exact position at which the spring is strongly deflected, noise damping can be achieved on abutment. Furthermore, a high friction between the components can thus be generated in a simple way.

To have another “adjusting screw”, by means of which the friction between the components of the supporting element can be adjusted, the noise-reducing coating can additionally be provided on a surface of the component facing away from the spring.

Furthermore, the noise-reducing coating can be formed such that the friction between at least two components is at least sectionally increased. This provides for stopping the opening or closing of the flap or door in a reliable and controlled way also in intermediate positions.

In a preferred embodiment, the noise-reducing coating at least sectionally is a flock coating. Such a flock coating can be applied by means of a simple coating method and constitutes a particularly noise-reducing surface.

In another embodiment, the noise-reducing coating at least sectionally is provided in the form of a paint layer. In contrast to a flock coating, the same can be a less expensive coating.

### BRIEF DESCRIPTION OF THE DRAWINGS

Further advantages and properties of the invention can be taken from the following description and the drawings to which reference is made, and in which:

FIG. 1 shows a schematic representation of a supporting element according to the invention in a longitudinal section;

FIG. 2a shows a schematic representation of the detail II of FIG. 1;

FIG. 2b shows an alternative embodiment of the area shown in FIG. 2a;

FIG. 2c shows another alternative embodiment of the area shown in FIG. 2a; and

FIG. 3 shows a schematic representation of the detail III of FIG. 1.

### DETAILED DESCRIPTION OF THE INVENTION

To illustrate the invention, the exemplary embodiments show a supporting element in the form of a spring strut, although other, similarly constructed supporting elements, such as a compact spindle, likewise are imaginable.

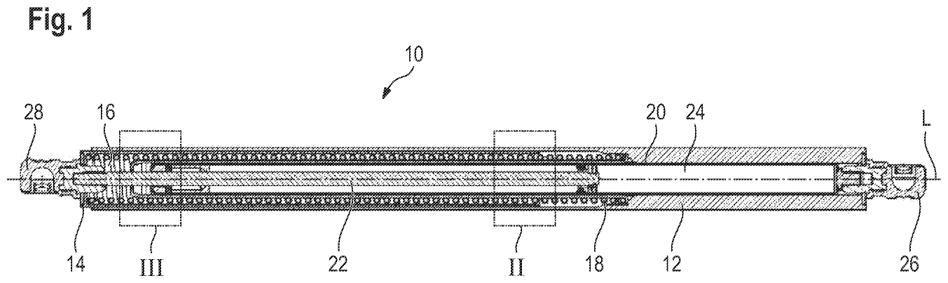

FIG. 1 shows a supporting element 10, here a spring strut, which includes a base part 12 and an extendable part 14 that is adjustable relative to the base part 12 along the longitudinal axis L. Between the base part 12 and the extendable part 14, a coil spring 16 is arranged, which on the one side is supported on the extendable part 14.

On the other side, the spring 16 is supported on a spring guide 18 that is designed within the spring 16. The spring guide 18 extends along the longitudinal axis L over at least a part of the length of the extendable part 14 and beyond the same into the base part 12 and is attached to the same so that the spring guide 18 is an element of the base part 12.

Alternatively, it is also imaginable that the spring guide 18 is attached to the extendable part 14 and thus is an element of the extendable part 14.

The spring guide 18 surrounds a gas pressure damper 20 comprising a piston rod 22 and a gas space 24.

The base part 12 is connected to a first connecting part 26, and the extendable part 14 is connected to a second connecting part 28. The two connecting parts 26 and 28 serve the external attachment of the supporting element 10. By its compressive force, the spring 16 supports the movement of the extendable part 14, while at the same time the gas pressure damper 20 dampens the movement of the extendable part 14 and thus prevents jerky jolts, in particular upon reaching the extended end position of the supporting element 10.

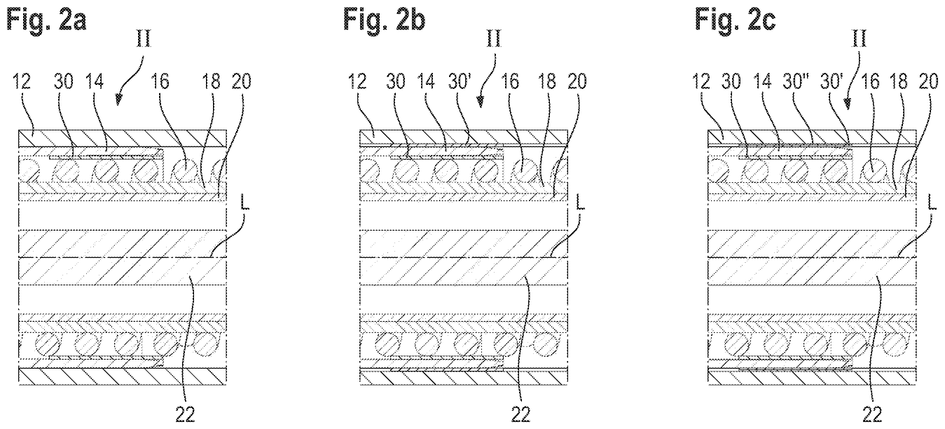

FIG. 2a shows an enlarged view of the detail II of FIG. 1. For the components known from the FIG. 1 the same reference numerals are used, and in so far reference is made to the above explanations. It can be seen that on the surface facing the spring 16, a noise-reducing coating 30, for example a flock coating and/or a paint, is sectionally applied on the extendable part 14. The coating 30 serves to dampen or even completely suppress the generation of noises, when a mechanical contact occurs between the spring 16 and the extendable part 14.

As can be seen in FIG. 2a, the coating 30 can be provided only at the axial end of the extendable part 14 facing away from the connecting part 28. The application of the noise-reducing coating 30 at this point is particularly advantageous, as due to the maximum distance from the abutment of the spring 16, the largest deflections of the spring 16 are to be expected there. In addition, the coils of the spring 16 are particularly likely to get in contact with the extendable part 14 at this point during the movement of the same, so that operating noises can be dampened particularly effectively at this point.

As is shown in FIG. 2a, only a part of the extendable part 14 is provided with the noise-reducing coating 30. In such a configuration, the costs can be reduced distinctly in the manufacturing process, as not the entire surface needs to be coated.

In the exemplary embodiment shown in FIG. 2a, the coating 30 extends in an axial direction, over a distance that corresponds to the height of three to four coils of the spring 16. It has been found that to effectively dampen noises, it is sufficient to apply the coating 30 on such a short area of the surface surrounding the spring 16. This results in a particularly good ratio between the expenditure, in particular the manufacturing costs, and the achieved noise damping.

It is also imaginable to arrange a plurality of areas with a coating 30, which in particular each extends at least over a spring coil, along the surface surrounding the spring 16 in such a way that the spring 16 is supported or damped at several points spaced apart from each other.

FIG. 2b shows a variant that differs from the embodiment shown in FIG. 2a with regard to the position of the coating. For the components known from FIGS. 1 and 2a the same reference numerals are used, and in so far reference is made to the above explanations.

In the variant shown in FIG. 2b, another coating 30′ is provided in addition to the coating 30, which faces the spring 16, namely on the side of the extendable part 14 facing the base part 12. This allows to effectively reduce in particular noises due to vibrations, as not only a contact of the spring 16 at the extendable part 14 is damped, but it is also prevented or at least attenuated that vibrations can be transmitted from the extendable part 14 to the base part 12.

Thus, it is also possible in addition to adjust the friction between the base part 12 and the extendable part 14 such that the supporting element 10 comes to a standstill in intermediate positions. This aspect of course requires to adjust the friction in the supporting element 10 to the weight of the flap or door with which the supporting element 10 is coupled.

In this embodiment, too, it is possible to apply the coatings 30, 30′ only along a part of the length of the component to be coated. It is also conceivable that the coating 30 on the surface of the extendable part 14 pointing to the spring and the coating 30′ on the surface of the extendable part 14 pointing to the base part 12 are applied on different sections.

FIG. 2c shows a variant that differs from the embodiments shown in FIGS. 2a and 2b with regard to the position of the coating and the coated components. For the components known from FIGS. 1, 2a and 2b the same reference numerals are used, and in so far reference is made to the above explanations.

In the variant shown in FIG. 2c, another coating 30″ is provided on the base part 12 in addition to the coatings 30 and 30′ applied on the extendable part 14, namely on the side of the base part 12 that faces the extendable part 14 and the spring 16. This provides another possibility of adjusting the coatings 30′ and 30″ to each other such that a desired friction between the base part 12 and the extendable part 14 as well as an effective noise reduction is achieved.

In this embodiment, too, it is possible to apply the coatings 30, 30′, 30″ only along a part of the length of the component to be coated. It is also conceivable that the coating 30 on the surface of the extendable part 14 pointing to the spring and the coating 30′ on the surface of the extendable part 14 pointing to the base part 12 as well as the coating 30″ on the surface of the base part 12 pointing to the extendable part 14 are applied on different sections.

In addition, it is also possible that the coating 30″ is applied on the base part 12 such that the coatings 30′ and 30″ face each other only in particular positions of the extendable part 14, in particular in the end positions and/or desired intermediate positions.

It is also conceivable that the coatings 30′ and 30″ are different materials, for example different paints.

In addition, the coatings 30, 30′ and 30″ shown in FIG. 2c can differ in their thickness.

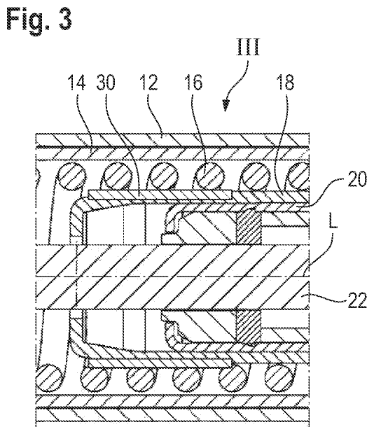

FIG. 3 shows an enlarged view of the detail III of FIG. 1. For the components known from FIGS. 1 and 2a to 2c the same reference numerals are used, and in so far reference is made to the above explanations. It can be seen that on the surface facing the spring 16, a noise-reducing coating 30, for example a flock coating and/or a paint, is sectionally applied on the spring guide 18. In this exemplary embodiment, the spring guide 18 is firmly connected to the base part 12 so that the spring guide 18 is an element of the base part 12. Alternatively, it is also imaginable that the spring guide 18 is connected to the extendable part 14.

As can be seen in FIG. 3, the coating 30 can be provided only at the axial end of the spring guide 18 facing the connecting part 28. The application of the noise-reducing coating 30 at this point is particularly advantageous, as during a movement of the extendable part 14, the spring 16 must arrange itself in this area between the extendable part 14 and the spring guide 18. As a result, the coils of the spring 16 are particularly likely to get in contact with the spring guide 18 at this point during a movement of the extendable part 14, so that operating noises can be dampened particularly effectively at this point.

In this embodiment, too, it is conceivable that in several areas of the spring guide 18 the coating 30, which in particular each extends at least over a spring coil, are arranged along the surface facing the spring 16 so that the spring 16 is supported or damped at several points spaced apart from each other.

The noise-reducing coating 30 also can extend over the entire length of the spring guide 18.

Furthermore, the different variants from FIGS. 2a to 2c and 3 can be combined with each other as desired in order to adjust a desired noise reduction and friction. The coatings 30, 30′ and 30″ can at least sectionally be designed as a flock coating. This allows to apply the same with little expenditure and to achieve good noise damping.

As the flock coating is applied on a continuous surface, which also has very little curvature, this surface can also be prepared for coating with little expenditure, for example by activating the surface, by applying an adhesive layer or by roughening the surface.

In another embodiment, the coatings 30, 30′ and 30″ can at least sectionally be configured in the form of a paint layer. As compared to the flock coating, this can provide for a less expensive manufacture, for example by dipping the component to be coated into a container that contains the paint.

It is also conceivable that different areas are provided with different types of coating. For example, the coating 30 pointing to the spring might be a flock coating which has particularly noise-reducing properties, while the surface of the extendable part 14 pointing to the base part 12 and/or the surface of the base part 12 pointing to the extendable part 14 has a paint layer that provides an increased friction and thus a secure hold in intermediate positions of the supporting element.

1. A supporting element for adjusting a flap or door of a motor vehicle, comprising a base part, an extendable part that is adjustable relative to the base part, and a spring that is arranged between the two parts, wherein a noise-reducing coating is provided, characterized in that the noise-reducing coating is arranged on the base part and/or extendable part on a surface facing the spring.

2. The supporting element according to claim 1, characterized in that the noise-reducing coating extends at least over a part portion of a length of the coated part such that the spring can be in contact with the coating at at least two points in every position of the supporting element.

3. The supporting element according to claim 1, characterized in that the noise-reducing coating extends over an entire length of the coated part.

4. The supporting element according to claim 1, characterized in that the noise-reducing coating additionally is disposed on a surface of the coated part facing away from the spring.

5. The supporting element according to claim 1, characterized in that the noise-reducing coating is configured such that friction between at least two components is at least sectionally increased.

6. The supporting element according to claim 1, characterized in that the noise-reducing coating at least sectionally is a flock coating.

7. The supporting element according to claim 1, characterized in that the noise-reducing coating at least sectionally is configured in the form a paint layer.
